(19) United States
(12) Patent Application Publication
(10) Pub. No.: US 2017/0147450 A1
(43) Pub. Date: May 25, 2017

(54) INFORMATION PROCESSING DEVICE, INFORMATION PROCESSING METHOD, AND PROGRAM RECORDING MEDIUM

(71) Applicant: NEC Corporation, Minato-ku, Tokyo (JP)

(72) Inventor: Toshinori TAKEMURA, Tokyo (JP)

(73) Assignee: NEC Corporation, Minato-ku, Tokyo (JP)

(21) Appl. No.: 15/301,844

(22) PCT Filed: May 11, 2015
(86) PCT No.: PCT/JP2015/002364

§ 371 Date: Oct. 4, 2016

(30) Foreign Application Priority Data
May 16, 2014 (JP) 2014-101950

(51) Int. Cl. G06F 11/14

(52) U.S. Cl. CPC G06F 11/1469; G06F 11/1471; G06F 3/0619

(57) ABSTRACT

The present invention discloses an information processing device with which it is possible to process a transaction at high speed. An information processing device according to the present disclosure is provided with: a nonvolatile device into which information pertaining to an executed process is written; a monitoring unit configured to save, upon detecting a write of the information to the nonvolatile device, the information stored in the nonvolatile device before the write; a history information storage unit configured to store the information saved by the monitoring unit as history information; and a restoration unit configured to restore, upon detection of a fault, the information stored in the nonvolatile device to information at a prescribed point of time on the basis of the history information stored by the history information storage unit.

### TECHNICAL FIELD

This invention relates to a technology for processing a transaction on an information processing device at a high speed.

### BACKGROUND ART

Recently, practical use of a universal memory which is a nonvolatile memory integrating functions of a work memory configured with a DRAM (Dynamic Random Access Memory) and a storage memory configured with a NAND has been widely spread. The use of this universal memory on a computer enables a file stored in a storage memory to be directly controlled and executed in a universal memory (nonvolatile memory) without being decompressed into a work memory. This computer can be controlled, for example, so that the power supply is turned off during non-operational hours and the power is supplied only when necessary. This results in reduction in power consumption, which can realize “normally-off computing”. For example, NPL 1 discloses a technology for realizing “normally-off” computing.

A technology called “in-memory DB” has also become popular for database management systems. The technology speeds up a DB search process with reading data stored on a table in a storage, that is, the data aggregate (DB: Data Base) organized in a table format into a volatile memory. In the in-memory DB, a DB including transaction process results is stored in a volatile memory.

In the in-memory DB, a DB search process can be speeded up because data stored in a DB is arranged in a volatile memory. However, for perpetuating the data arranged in the volatile memory, a process of writing data into a storage device (an auxiliary storage), such as a magnetic disk device or a NAND memory, is required. This perpetuation process takes time because the storage device is slower to read and write data compared with a volatile memory.

It is therefore contemplated that data perpetuation process is speeded up by the use of a high speed readable and writable nonvolatile device (a nonvolatile memory) for a memory that realizes the in-memory DB.

NPL 2 discloses a mechanism regarding the data perpetuation in the in-memory DB.

Also, PTL 1 discloses a process execution device for overcoming a fault to successfully continue process handling even if there is a time lag between a cause occurrence and an appearance of the fault.

Also, PTL 2 discloses a data restoration method for restraining performance degradation in access from a database application at a check point and shortening recovery time at a fault recovery by restraining an amount of disk output data at the check point.

### CITATION LIST

### Patent Literature

PTL 1: Japanese Patent Application Laid-open Publication No. 2011-022959
PTL 2: Japanese Patent Application Laid-open Publication No. 2006-139696

### Non-Patent Literature

NPL 1: http://news.mynavi.jp/articles/2013/05/08/noff/ retrieved on Apr. 23, 2014
NPL 2: http://www.publickey1.jp/blog/13/_3.html retrieved on Apr. 23, 2014

### SUMMARY OF INVENTION

### Technical Problem

As described above, data perpetuation process can be speeded up by using a high speed readable and writable nonvolatile device for a memory that realizes an in-memory DB. In this case, however, for making possible the DB to be restored at a fault occurrence, it is necessary to outputting history data about a transaction to a log file (a transaction log). The outputting of the transaction log takes a long time.

As described above, because writing to a storage device or outputting a transaction log takes time, there is a problem that the data perpetuation process becomes a bottleneck also in the in-memory DB, which leads to a long transaction process.

The aforementioned PTL 1 discloses that contents of an internal memory are dumped when process handling execution reaches a check point, but does not disclose a technology for processing a transaction at a high speed.

Also, the aforementioned PTL 2 discloses that target data at a check point is divided and that journal information that is history information on data update is output. In this literature, this journal information is used for recovering a database from a check point to the latest state, but a transaction cannot be processed at a high speed because a process of outputting this journal information to a disk takes time.

The present invention is made considering the above problems and it is a main object to provide an information processing device or the like which can process a transaction at a high speed.

### Solution to Problem

An information processing device according to the one aspect of the present invention includes:
a nonvolatile device into which information pertaining to executed processes is written,
monitoring means for saving, when detecting a write of the information in the nonvolatile device, the information which has been stored in the nonvolatile device before the write,
history information storage means for storing the information saved by the monitoring means as history information, and
restoration means for restoring, when detecting a fault, the information stored in the nonvolatile device to a state of the information at a prescribed point of time based on the history information stored in the history information storage means.

An information processing method according to the one aspect of the present invention includes:
storing, when detecting a write of the information in a nonvolatile device into which information pertaining to executed processes is written, the information which has been stored in the nonvolatile device before the write as history information in history information storage means,
restoring, when detecting a fault, the information stored in the nonvolatile device to a state of the information at a prescribed point of time based on the history information stored in the history information storage means.

In addition, the object is also achieved by a computer program that achieves the information processing device or the information processing method having each of the above-described configurations with a computer, and a computer-readable recording medium that stores the computer program.

### Advantageous Effects of Invention

According to the present invention, an advantageous effect of processing a transaction at a high speed can be obtained.

### BRIEF DESCRIPTION OF DRAWINGS

FIG. 1 is a functional block diagram showing a configuration of the information processing device according to a first exemplary embodiment of the present invention;

FIG. 2 is a flowchart showing an operation of a monitoring unit in the information processing device according to the first exemplary embodiment of the present invention;

FIG. 3 is a flowchart showing an operation of a restoration unit in the information processing device according to the first exemplary embodiment of the present invention;

FIG. 4 is a diagram schematically showing history data of transactions executed on a memory in the information processing device according to the first exemplary embodiment of the present invention;

FIG. 5 is a functional block diagram showing a configuration of the information processing device according to a second exemplary embodiment of the present invention;

FIG. 6 is a flowchart showing an operation of a DB monitoring unit in the information processing device according to the second exemplary embodiment of the present invention;

FIG. 7 is a flowchart showing an operation of the restoration unit in the information processing device according to the second exemplary embodiment of the present invention;

FIG. 8 is a functional block diagram showing a configuration of the information processing device according to a third exemplary embodiment of the present invention;

FIG. 9 is a flowchart showing an operation of a transaction monitoring unit in the information processing device according to the third exemplary embodiment of the present invention;

FIG. 10 is a flowchart showing an operation of the restoration unit in the information processing device according to the third exemplary embodiment of the present invention;

FIG. 11 is a functional block diagram showing a configuration of the information processing device according to a fourth exemplary embodiment of the present invention;

FIG. 12 is a flowchart showing an operation of the transaction monitoring unit in the information processing device according to the fourth exemplary embodiment of the present invention;

FIG. 13 is a flowchart showing an operation of the restoration unit in the information processing device according to the fourth exemplary embodiment of the present invention;

FIG. 14 is a functional block diagram showing a configuration of the information processing device according to a fifth exemplary embodiment of the present invention; and

FIG. 15 is a diagram illustrating a hardware configuration of the information processing device according to each exemplary embodiment of the present invention.

### DESCRIPTION OF EMBODIMENTS

Hereinafter, exemplary embodiments of the present invention will be explained in detail with reference to the figures.

### First Exemplary Embodiment

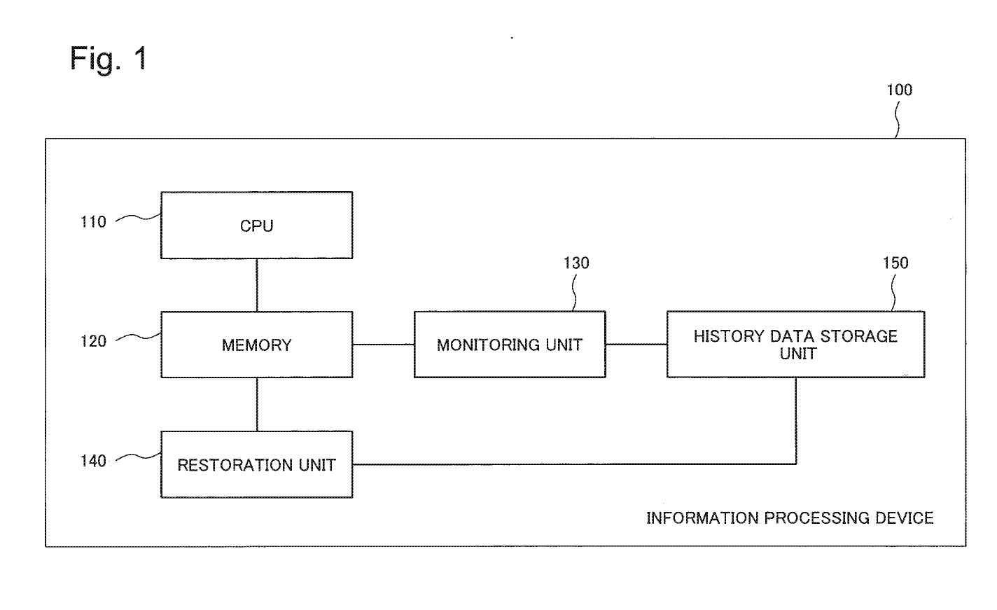

FIG. 1 is a functional block diagram showing a configuration of an information processing device 100 according to a first exemplary embodiment of the present invention. As shown in FIG. 1, the information processing device 100 includes a CPU (Central Processing Unit) 110, a memory 120, a monitoring unit 130, a restoration unit 140, and a history data storage unit 150.

Components included in the information processing device 100 will be briefly explained.

The CPU 110 reads a program, data, and the like stored in the memory 120 and executes a process according to the read program.

The memory 120 is configured with a nonvolatile device, and functions as an in-memory DB, which is configured with tables storing various data and the like, and also stores a program, data, execution results of the program, and the like. The in-memory DB will also be referred to as simply “DB” or “a DB table”.

The memory 120 is configured with a semiconductor memory which allows for writing and reading at a high speed and has high rewrite durability. It is assumed that the memory 120 is, for example, STT-MRAM (Spin Transfer Torque Magnetic Random Access Memory). Alternatively, it is assumed to be FeRAM (Ferroelectric Random Access Memory), MRAM (Magnetoresistive Random Access Memory), PRAM (Phase change Random Access Memory), ReRAM (Resistive Random Access Memory), or the like. However, it is not limited to the examples above, and another nonvolatile device, such as SSD (Solid State Drive) and HDD (Hard Disk Drive), which can perpetuate data, may be used.

The monitoring unit 130 monitors writing of data by the CPU 110 to the memory 120 and stores history data (the details are described below) in the history data storage unit 150 when a write is detected.

The history data storage unit 150 stores history data. The restoration unit 140 restores the memory 120 to its state at an arbitrary timing based on the history data stored in the history data storage unit 150. The history data storage unit 150 is assumed to be a nonvolatile device as described above.

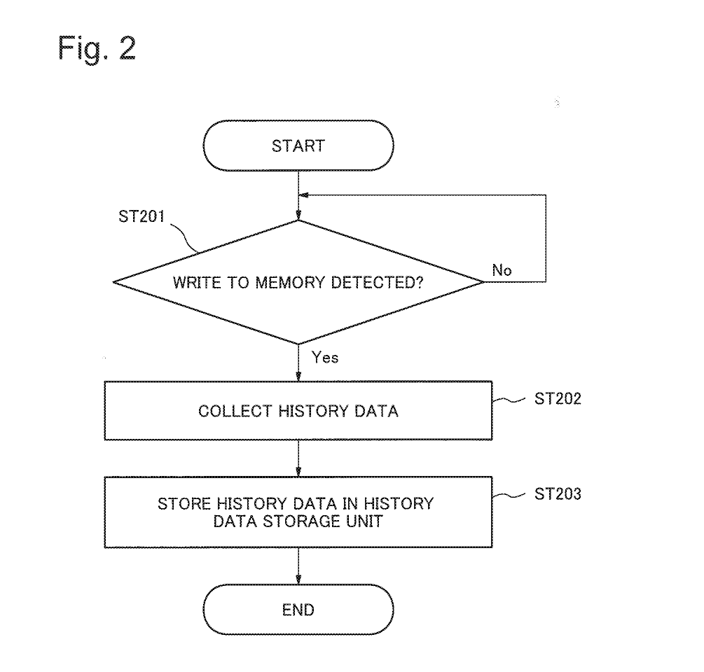

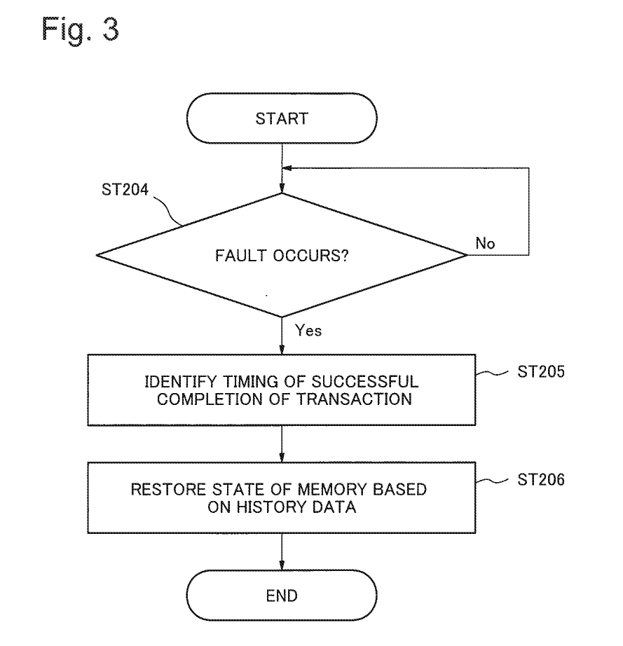

FIG. 2 is a flowchart showing an operation of the monitoring unit 130 in the information processing device 100. FIG. 3 is also a flowchart showing an operation of the restoration unit 140 in the information processing device 100. An operation of the information processing device 100 will be explained with reference to FIGS. 2 and 3.

In the figures, the CPU 110 executes a plurality of transactions, each of which is an inseparable series of multiple processes related to each other and grouped together. At this time, the CPU 110 writes results of program execution and transaction processing into the memory 120.

When detecting a write to the memory 120 by the CPU 110 (Yes in step ST201), the monitoring unit 130 collects data regarding the write (step ST202). The data regarding the above write is referred to as “history data”.

The history data includes contents of the memory 120 before a write (update) by the CPU 110, an update time, the number of a generated interrupt signal, information showing a CPU register state, a program counter, and the like. These “contents of the memory 120 before a write” included in the history data are the contents of the memory before the update, the memory being detected by the monitoring unit 130 a write by the CPU 110, among a program, data used by such program, an execution result of the program, a DB table, and the like stored in the memory 120. It is noted that the history data may be byte data that shows an execution state of the information processing device 100 and is readable by the CPU 110.

The monitoring unit 130 stores the collected history data in the history data storage unit 150 (step ST203). The monitoring unit 130 repeats the steps ST202 and ST203 every time it detects a write to the memory 120 by the CPU 110.

FIG. 3 as shown subsequently assumes that a fault occurrence is detected in the information processing device 100 (Yes in step ST204). If a fault is detected, the restoration unit 140 identifies the timing of the last successful completion of the transaction before the fault based on the history data stored in the history data storage unit 150 (step ST205).

Specifically, the restoration unit 140 identifies the timing of the last successful completion of the transaction as described below. The restoration unit 140 matches executed processes of the program with the program counter stored in the history data storage unit 150. As the program counter indicates a program execution location, the above matching reveals what kind of processes (transaction) have been executed. The restoration unit 140 can determine how far it needs to go back to reach the timing of the last successful completion of the transaction before the fault based on the processed contents of the program, stored in locations that the program counter indicates.

For example, when the restoration unit 140 does not find out, in a location indicated by a value of the program counter, that the processed contents stored in the location show the timing of successful completion of the transaction, the restoration unit 140 goes to the location indicated by the immediately preceding value of the program counter to check the processed contents stored therein. By repeating this operation, the restoration unit 140 determines the timing of successful completion of the transaction.

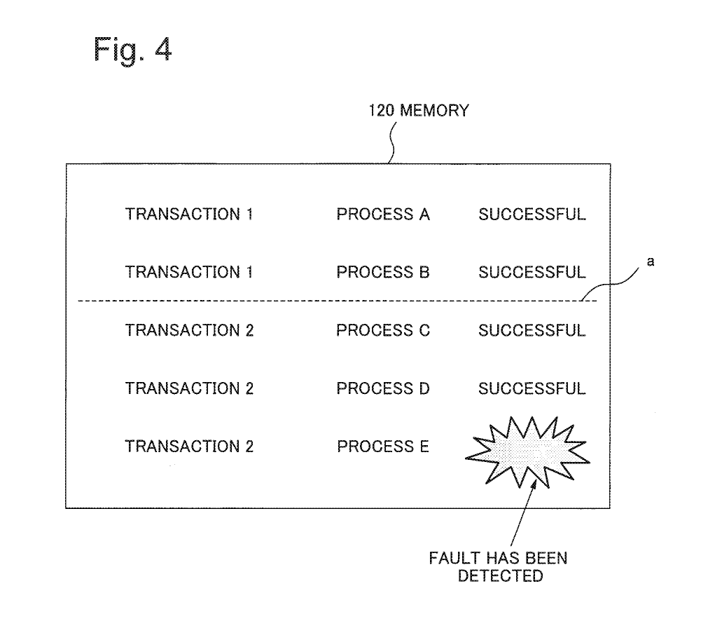

For example, FIG. 4 is a diagram schematically showing history data of transactions executed on the memory 120. In FIG. 4, it is assumed that processes A to E are executed on the memory 120, the processes A and B carrying identification information for a transaction 1 while the processes C, D, and E for a transaction 2. It is assumed that a fault has been detected in the process E. It this case, the restoration unit 140 checks whether the process immediately before the process E shows a timing of a successful completion of the transaction. The process executed immediately before the process E here does not show a timing of a successful completion of the transaction because the process which is the process D, carries identification information for the transaction 2, as the process E does. The restoration unit 140 then checks the process executed immediately further before the process D. The process immediately before the process D, which is the process C, also does not show a timing of a successful completion of the transaction because it also carries identification information for the transaction 2, as the process E does. The restoration unit 140 then goes even further and checks the process executed immediately before the process C. The process immediately before the process C, which is the process B, shows a timing of a successful completion of the transaction because it carries identification information for the transaction 1, unlike the process E. Accordingly, the restoration unit 140 determines that this timing (the timing shown by “a” in FIG. 4) is the time of the last successful completion of the transaction before the fault.

When the restoration unit 140 identifies the timing of the last successful completion of the transaction, it restores in the memory 120 the information (state) that the memory 120 retained at the time of the last successful completion of the transaction, based on the history data stored in the history data storage unit 150 (step ST206). In this case, the restoration unit 140 deletes, for example, the information on the process E from the memory 120, then deletes the information on the process D, and further deletes the information on the process C, as all these processes carry identification information for the transaction 2. This causes the memory 120 to be restored to its state at the time of the last successful completion of the transaction.

The information processing device 100 uses the memory 120 restored as described above to resume a process. At this time, depending on a fault type, it may be hard to resume a process in the information processing device 100. Therefore, depending on a fault type, a process may be resumed in the information processing device 100 or the above history data may be copied from the information processing device 100 to a memory included in a different information processing device to resume the above process in the different information processing device.

As above, according to this first exemplary embodiment, in the information processing device 100, the monitoring unit 130 monitors writes to the memory 120, and stores the history data described above in the history data storage unit 150 when a write is detected. It means that the information processing device 100 stores information stored by the memory 120 in the history data storage unit 150 without writing to a storage device for perpetuation or outputting a transaction log. If a fault is detected, the restoration unit 140 identifies the timing of the last successful completion of the transaction before the fault based on the history data and recovers the state of the memory 120 by restoring data stored at that time.

According to this first exemplary embodiment, this configuration enables the information processing device 100 to process a transaction without outputting a transaction log or writing data to a storage device, which takes a relatively long time. Therefore, according to this first exemplary embodiment, an advantageous effect of processing a transaction at a high speed can be obtained.

Also, according to this first exemplary embodiment, an advantageous effect of restoring the DB to its state at the time of a fault occurrence at a high speed can be obtained because the restoration unit 140 restores the memory 120 to its state at the time of a successful completion of the transaction by tracing back the history data stored in the history data storage unit 150.

An information processing device of a related technology is now explained. In an information processing device that recovers a DB using a transaction log, when a fault is detected, transactions are executed on check point data, which is backup data saved in a consistent state, in the order recorded in the transaction log. This causes the information processing device to restore the DB to the latest state. This DB recovery using a transaction log takes a long time. In contrast, according to this first exemplary embodiment, a DB is not recovered using a transaction log, but the state of the memory 120 is recovered using the history data stored in the history data storage unit 150, as described above. Therefore, according to this first exemplary embodiment, an advantageous effect of recovering a DB at a high speed in the case of a fault occurrence can be obtained.

### Second Exemplary Embodiment

Next, a second exemplary embodiment based on the aforementioned first exemplary embodiment will be explained. In the following explanation, same reference numerals are assigned to components similar to the first exemplary embodiment, and overlapping explanations are omitted.

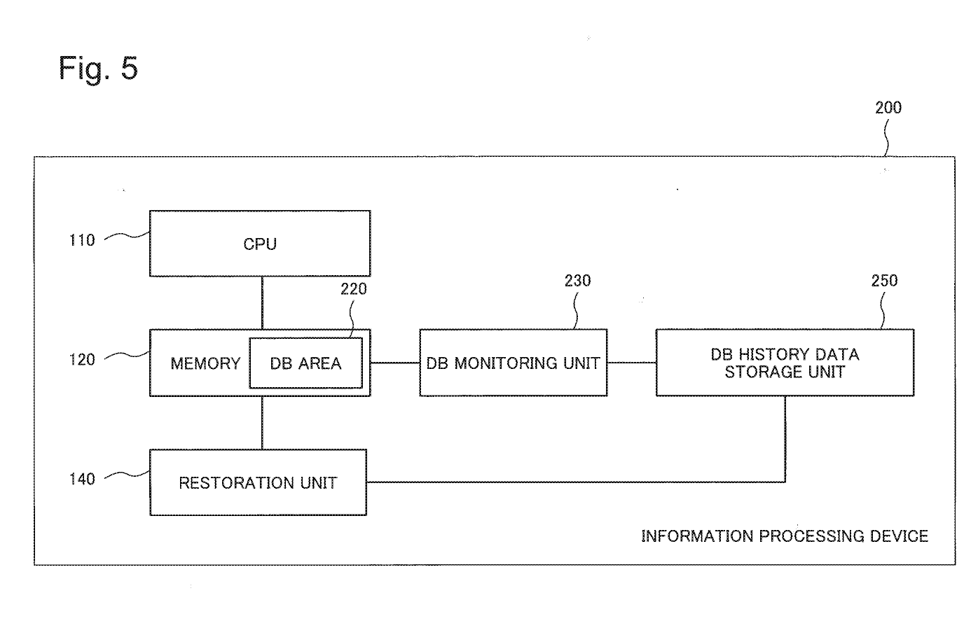

FIG. 5 is a functional block diagram showing a configuration of an information processing device 200 according to the second exemplary embodiment of the present invention. As shown in FIG. 5, the information processing device 200 includes a DB monitoring unit 230 and a DB history data storage unit 250 instead of the monitoring unit 130 and the history data storage unit 150 respectively, which are included by the information processing device 100 according to the first exemplary embodiment above.

As explained in the first exemplary embodiment, the CPU 110 writes, for example, program execution and transaction process results to the memory 120. In this second exemplary embodiment, the case where data about a DB including a transaction process result among writes from the CPU 110 to the memory 120 is written into a DB area 220 is explained.

The DB monitoring unit 230 monitors writing data to the DB area 220 of the memory 120 and stores DB history data (the details are described below) in the DB history data storage unit 250 when a write is detected. This writing to the DB area 220 includes writes of data stored in the DB (a DB table) as well as information related to such DB table, such as an index.

The DB history data storage unit 250 stores the DB history data described above. The restoration unit 140 restores the DB area 220 of the memory 120 to its state at any desired timing based on the DB history data stored in the DB history data storage unit 250.

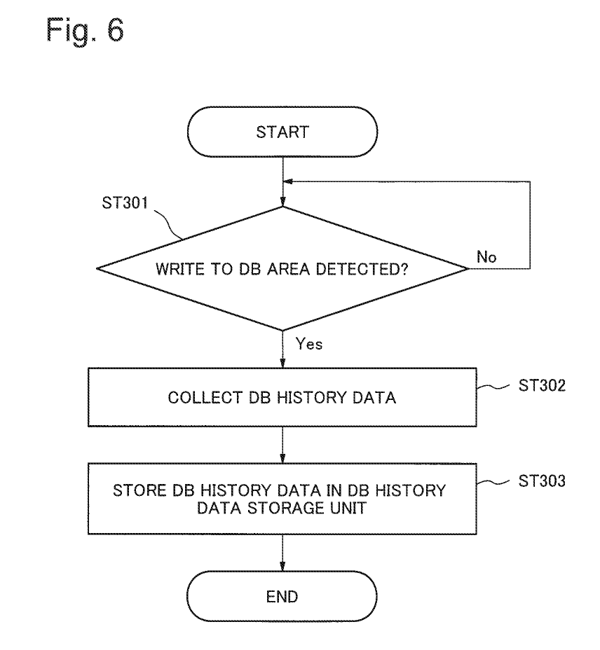

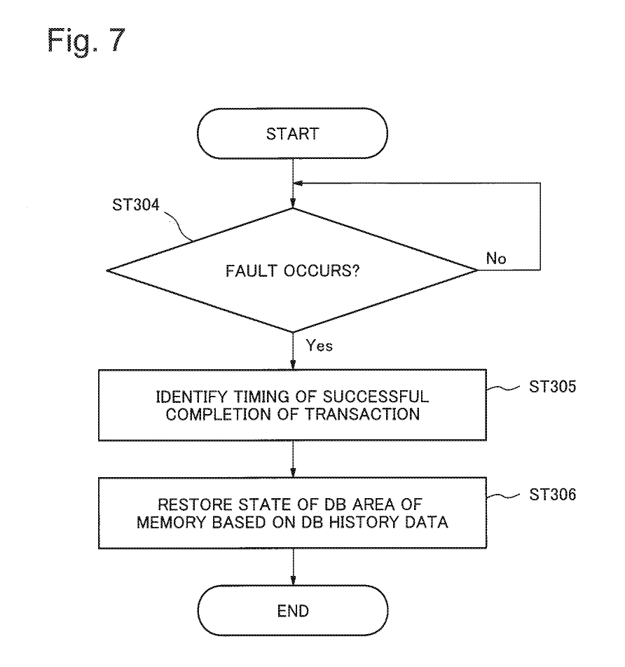

FIG. 6 is a flowchart showing an operation of the DB monitoring unit 230 in the information processing device 200. FIG. 7 is also a flowchart showing an operation of the restoration unit 140 in the information processing device 200. An operation of the information processing device 200 will be explained with reference to FIGS. 6 and 7.

As with the first exemplary embodiment, the CPU 110 executes a plurality of transactions, each of which is an inseparable series of multiple processes related to each other and grouped together. At this time, the CPU 110 writes results of program execution and transaction processing into the memory 120, which include the DB area 220.

When the DB monitoring unit 230 detects a write to the DB area 220 of the memory 120 (Yes in step ST301), it collects data about the write (step ST302). The data about the above write is referred to as “DB history data”.

The DB history data includes contents of the DB area 220 before a write (update) by the CPU 110, an update time, a transaction ID (Identification) for identifying a series of processes (a transaction), and the like. The “contents of the DB area 220 before a write (update)” included in the DB history data are the contents of the DB area 220 before the update, the DB area 220 being detected by the DB monitoring unit 230 a write by the CPU 110, among a program, data used by such program, an execution result of the program, a DB table, and the like stored in the memory 120. It is to be noted that the DB history data may be byte data that shows an execution state of the information processing device 100 and is readable by the CPU 110.

The DB monitoring unit 230 stores the collected DB history data in the DB history data storage unit 250 (step ST303). The DB monitoring unit 230 repeats the steps ST302 and ST303 every time it detects a write to the DB area 220.

FIG. 7 as shown subsequently assumes that a fault occurrence is detected in the information processing device 200 (Yes in step ST304). When a fault is detected, the restoration unit 140 identifies the timing of the last successful completion of the transaction before the fault based on the DB history data stored in the DB history data storage unit 250 (step ST305).

In this case, a break between transaction IDs included in the DB history data shows a break of processes (transactions). Therefore, if a series of DB history data with a certain transaction ID sequentially or non-sequentially appears in the DB history data, a timing when the last DB history data with the transaction ID appears indicates the timing of the last successful completion of the transaction. In this manner, the restoration unit 140 identifies the timing when the last DB history data with the certain transaction ID appears as the timing of the last successful completion of the transaction.

When the restoration unit 140 identifies the timing of the last successful completion of the transaction, it restores a state of the DB area 220 of the memory 120 to its state at the timing of the aforementioned successful completion of the transaction based on the DB history data stored in the DB history data storage unit 250 (step ST306). This causes the DB area 220 of the memory 120 to be restored to its state at the time of the completion of the last successful completion of the transaction.

The information processing device 200 uses the DB area 220 of the memory 120 restored as described above to resume a process. As with the first exemplary embodiment, depending on a fault type, a process may be resumed in the information processing device 200 or the above DB history data may be copied from the information processing device 200 to a memory included in a different information processing device to resume the above process in the different information processing device.

As above, according to this second exemplary embodiment, in the information processing device 200, the DB monitoring unit 230 monitors writes to the DB area 220 of the memory 120 and stores the DB history data described above in the DB history data storage unit 250 when a write is detected. It means that the information processing device 200 stores a DB table written into the DB area 220 in the DB history data storage unit 250 without writing to a storage device for perpetuation or outputting transaction logs. If a fault is detected, the restoration unit 140 identifies the timing of the last successful completion of the transaction before the fault based on the DB history data and recovers the state of the DB area 220 by restoring the DB table to its state stored at that time.

According to this second exemplary embodiment, this configuration enables the information processing device 200 to process a transaction without outputting transaction log or writing data to a storage device, which takes a relatively long time. Therefore, according to this second exemplary embodiment, an advantageous effect of processing a transaction at a high speed can be obtained.

Also, according to this second exemplary embodiment, compared with the information processing device 100 according to first exemplary embodiment where the data stored in the memory 120 is stored in the history data storage unit 150, only the DB history data collected in the case of an occurrence of a write to the DB area 220 is stored in the DB history data storage unit 250. Therefore, according to this second exemplary embodiment, an advantageous effect of processing a transaction at an even higher speed than the first exemplary embodiment can be obtained because there is less data to be stored in the DB history data storage unit 250.

In addition, because there is less data to be stored in the DB history data storage unit 250 as described above, an advantageous effect of making the capacity of the DB history data storage unit 250 smaller than that of the history data storage unit 150 explained in the first exemplary embodiment can be obtained. Further, because the capacity of the DB history data storage unit 250 can be reduced in this manner, an advantageous effect of shortening the time for the process of recovering the state of the memory 120 (the DB area 220) as compared with the first exemplary embodiment can be obtained.

### Third Exemplary Embodiment

Next, a third exemplary embodiment based on the aforementioned first exemplary embodiment will be explained. In the following explanation, same reference numerals are assigned to components similar to the third exemplary embodiment, and overlapping explanations are omitted.

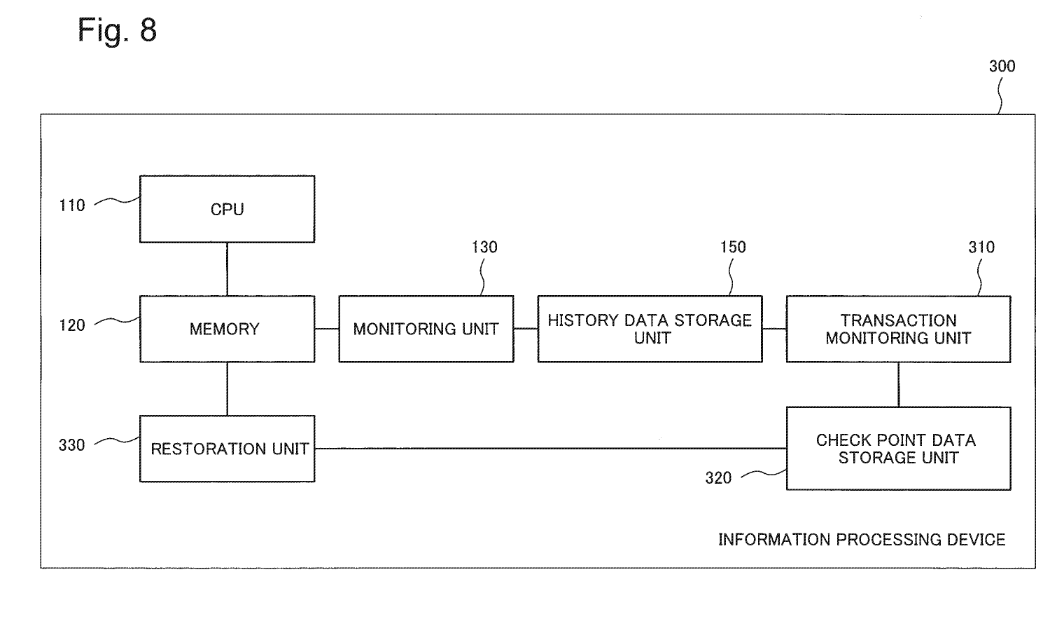

FIG. 8 is a functional block diagram showing a configuration of the information processing device 300 according to the third exemplary embodiment of the present invention. As shown in FIG. 8, the information processing device 300 includes a restoration unit 330 instead of the restoration unit 140 in the information processing device 100 according to the first exemplary embodiment, and further a transaction monitoring unit (first process monitoring means) 310 and a check point data storage unit (first check point data storage means) 320.

The transaction monitoring unit 310 monitors history data stored in the history data storage unit 150 and stores contents of the history data storage unit 150 in the check point data storage unit 320 every time a transaction is successfully completed.

The check point data storage unit 320 stores the contents stored in the history data storage unit 150 at the time (a check point) of every successful completion of a transaction.

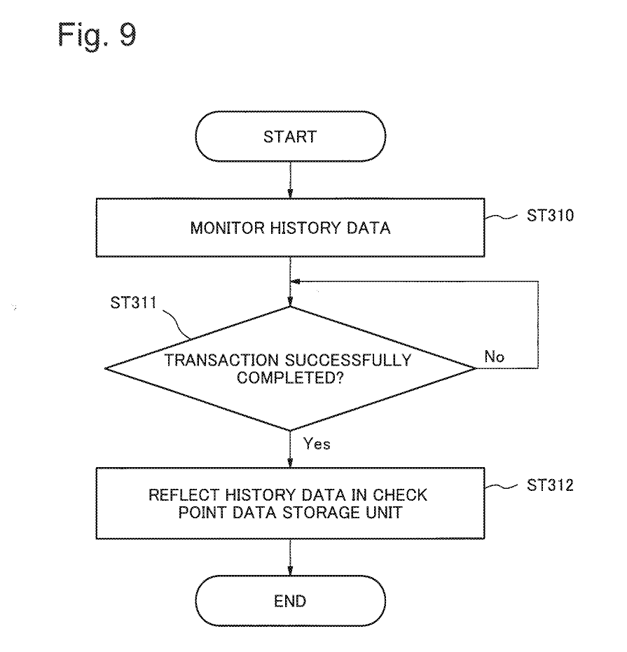

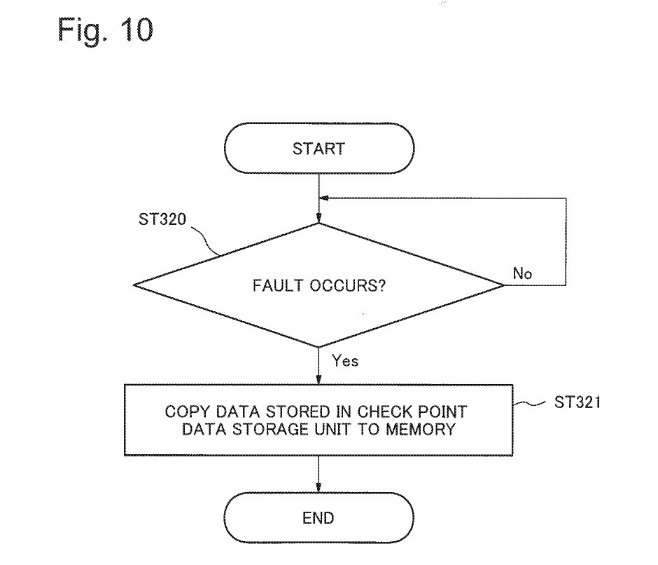

FIG. 9 is a flowchart showing an operation of the transaction monitoring unit 310 in the information processing device 300. FIG. 10 is also a flowchart showing an operation of the restoration unit 330 in the information processing device 300. An operation of the information processing device 300 will be explained with reference to FIGS. 9 and 10.

As with the first exemplary embodiment, the CPU 110 executes a plurality of transactions, each of which is an inseparable series of multiple processes related to each other and grouped together. At this time, the CPU 110 writes results of program execution and transaction processing into the memory 120.

The monitoring unit 130 performs an operation similar to the one explained with reference to the flowchart shown in FIG. 2 in the first exemplary embodiment. Therefore, when the monitoring unit 130 detects a write to the memory 120, it collects data about the write and stores the collected data in the history data storage unit 150.

The transaction monitoring unit 310 monitors the history data storage unit 150 (step ST310), and detects the timing of a successful completion of the transaction based on the history data stored in the history data storage unit 150 (step ST311).

It means that, every time history data is stored in the history data storage unit 150 by the monitoring unit 130, the transaction monitoring unit 310 monitors whether it is a timing of a successful completion of the transaction. When the transaction monitoring unit 310 detects that it is such a timing, the history data at that timing (check point data) is stored in a memory with which the check point data storage unit 320 is configured (step ST312). Therefore, the transaction monitoring unit 310 accurately reflects the contents of the memory 120 at the timing of the successful completion of the transaction in the check point data storage unit 320. The history data to be used for updating at this time is the history data acquired since the last update.

The transaction monitoring unit 310 detects the timing of a successful completion of the transaction based on processed contents stored in a location indicated by a program counter included in the history data.

Alternatively, the transaction monitoring unit 310 may store the history data in the check point data storage unit 320 at a regular interval. This regular interval may be a prescribed time interval, an interval defined by a predetermined number N of writes to the memory 120 (N is a positive number), an interval defined by a predetermined number of times a predetermined, measurable thing occurs, or an interval defined by any combinations thereof.

FIG. 10 as shown subsequently assumes that a fault occurrence is detected in the information processing device 300 (Yes in step ST320). When a fault is detected, the restoration unit 330 copies the check point data stored in the check point data storage unit 320 to the memory 120 (step ST321). This causes the memory 120 to be restored to its state at the time of the last successful completion of the transaction.

The information processing device 300 uses the memory 120 restored as described above to resume a process. As with the first exemplary embodiment, depending on a fault type, a process may be resumed in the information processing device 300 or the above check point data may be copied from the information processing device 300 to a memory included in a different information processing device to resume the above process in the different information processing device.

As above, according to this third exemplary embodiment, in the information processing device 300, the transaction monitoring unit 310 monitors the history data stored in the history data storage unit 150 and stores the history data (check point data) in the check point data storage unit 320 every time a transaction is successfully completed. When a fault is detected, the restoration unit 330 copies the check point data stored in the check point data storage unit 320 to the memory 120. According to this third exemplary embodiment, employing this configuration does not require tracing back the history data to identify the timing of the last successful completion of the transaction, but enables the DB to be recovered simply by copying the check point data stored in the check point data storage unit 320 to the memory 120. Therefore, according to this third exemplary embodiment, an advantageous effect of recovering a DB at a higher speed than the operation shown in the first exemplary embodiment can be obtained in the case of a fault occurrence.

### Fourth Exemplary Embodiment

Next, the fourth exemplary embodiment based on the second exemplary embodiment is explained. In the following explanation, same reference numerals are assigned to components similar to the second exemplary embodiment, and overlapping explanations are omitted.

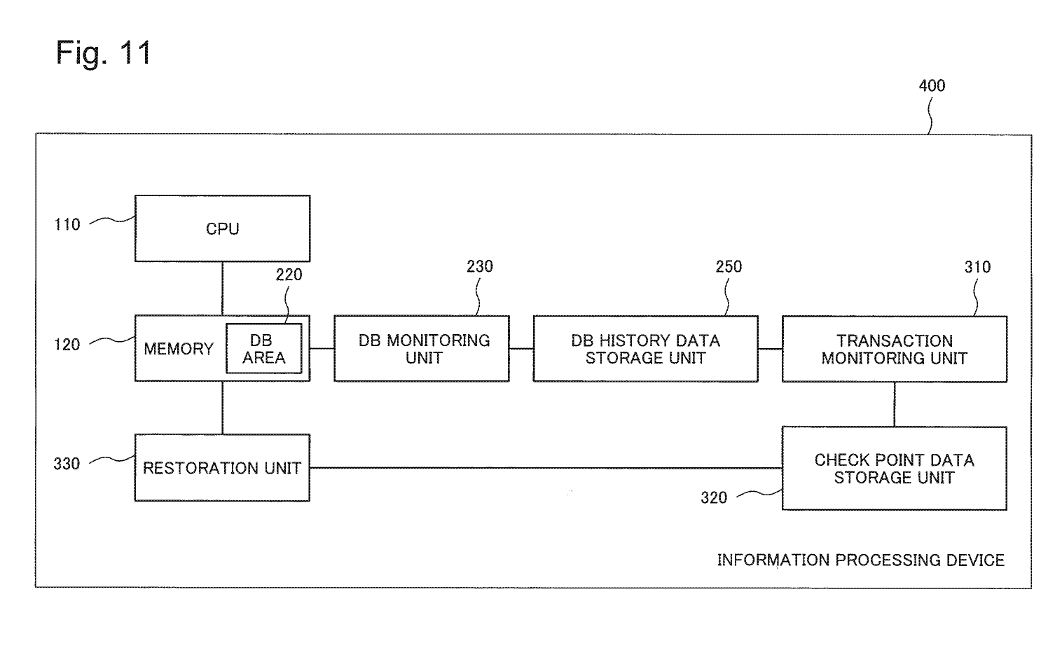

FIG. 11 is a functional block diagram showing a configuration of an information processing device 400 according to the fourth exemplary embodiment of the present invention. As shown in FIG. 11, the information processing device 400 includes a restoration unit 330 instead of the restoration unit 140 included by the information processing device 200 according to the aforementioned second exemplary embodiment, and further a transaction monitoring unit 310 and a check point data storage unit 320. The transaction monitoring unit (second process monitoring means) 310 and the check point data storage unit (second check point data storage means) 320 perform an operation similar to the one explained in the aforementioned third exemplary embodiment.

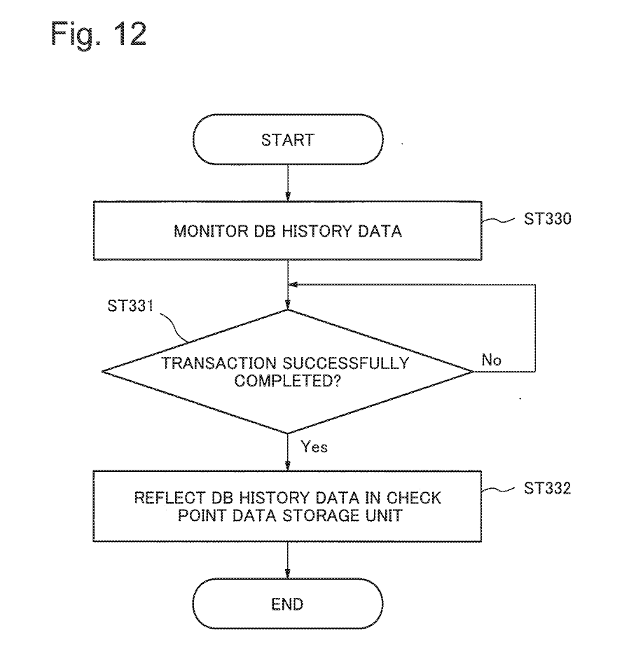

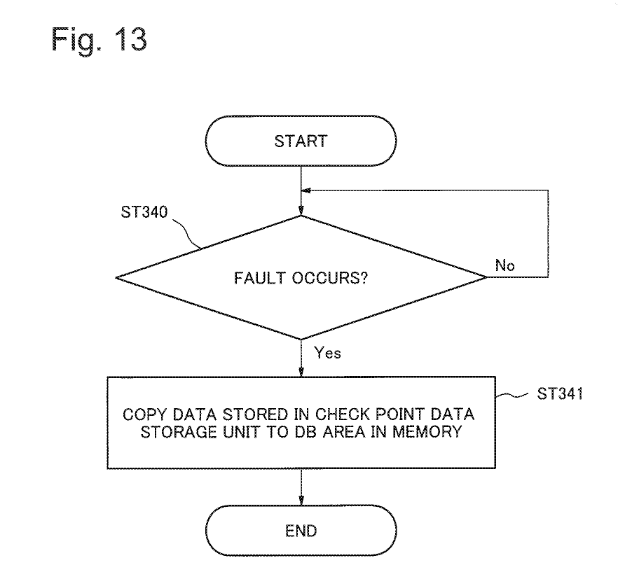

FIG. 12 is a flowchart showing an operation of the transaction monitoring unit 310 in the information processing device 400. FIG. 13 is also a flowchart showing an operation of the restoration unit 330 in the information processing device 400. An operation of the information processing device 400 will be explained with reference to FIGS. 12 and 13.

As with the first exemplary embodiment, the CPU 110 executes a plurality of transactions, each of which is an inseparable series of multiple processes related to each other and grouped together. At this time, the CPU 110 writes results of program execution and transaction processing into the memory 120.

The DB monitoring unit 230 performs an operation similar to the one explained with reference to the flowchart shown in FIG. 6 in the second exemplary embodiment. Therefore, when the DB monitoring unit 230 detects a write to the DB area 220 of the memory 120, it collects data about the write and stores the collected data in the DB history data storage unit 250.

The transaction monitoring unit 310 monitors the DB history data storage unit 250 (step ST330), and detects the timing of a successful completion of the transaction based on DB history data stored in the DB history data storage unit 250 (step ST331).

It means that, every time DB history data is stored in the DB history data storage unit 250 by the DB monitoring unit 230, the transaction monitoring unit 310 monitors whether it is a timing of a successful completion of the transaction. When the transaction monitoring unit 310 detects that it is such a timing, the DB history data (check point data) at that timing is stored in a memory with which the check point data storage unit 320 is configured (step ST332). Therefore, the transaction monitoring unit 310 accurately reflects the contents of the DB area 220 of the memory 120 at the timing of the successful completion of the transaction in the check point data storage unit 320. The DB history data to be used for updating at this time is the DB history data acquired since the last update.

The transaction monitoring unit 310 detects the timing of appearance of the last DB history data in the DB history data with a certain transaction ID as the timing of the successful completion of the transaction.

Alternatively, the transaction monitoring unit 310 may store the DB history data in the check point data storage unit 320 at a regular interval. This regular interval may be a prescribed time interval, an interval defined by a predetermined number N of writes to the DB area 220 of the memory 120 (N is a positive number) in the interval, an interval defined by a predetermined number of times a predetermined, measurable thing occurs in the interval, or an interval defined by any combinations thereof.

FIG. 13 as shown subsequently assumes that a fault occurrence is detected in the information processing device 400 (Yes in step ST340). When a fault is detected, the restoration unit 330 copies the check point data stored in the check point data storage unit 320 to the DB area 220 in the memory 120 (step ST341). This causes the DB area 220 of the memory 120 to be restored to its state at the time of the last successful completion of the transaction.

The information processing device 400 uses the DB area 220 restored as described above to resume a process. As with the first exemplary embodiment, depending on a fault type, a process may be resumed in the information processing device 400 or the above DB history data may be copied from the information processing device 400 to a memory included by a different information processing device to resume the above process in the different information processing device.

As above, according to this fourth exemplary embodiment, in the information processing device 400, the transaction monitoring unit 310 monitors the DB history data stored in the DB history data storage unit 250 and stores the DB history data (check point data) in the check point data storage unit 320 every time a transaction is successfully completed. When a fault is detected, the restoration unit 330 copies the check point data stored in the check point data storage unit 320 to the DB area 220 of the memory 120. According to this fourth exemplary embodiment, employing this configuration does not require determining the timing of the last successful completion of the transaction based on a transaction ID, but enables the DB to be recovered simply by copying the check point data stored in the check point data storage unit 320 to the DB area 220 of the memory 120. Therefore, according to this fourth exemplary embodiment, an advantageous effect of recovering a DB at a higher speed than the operation shown in the second exemplary embodiment can be obtained in the case of a fault occurrence.

### Fifth Exemplary Embodiment

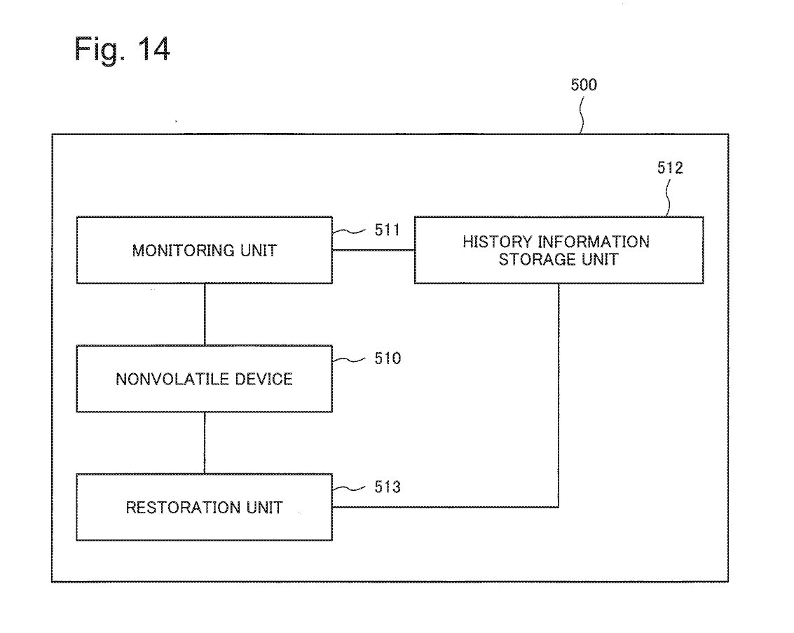

FIG. 14 is a functional block diagram showing a configuration of an information processing device 500 according to a fifth exemplary embodiment of the present invention. As shown in FIG. 14, the information processing device 500 includes a nonvolatile device 510, a monitoring unit 511, a history information storage unit 512, and a restoration unit 513.

Into the nonvolatile device 510, information pertaining to executed processes is written. When the monitoring unit 511 detects a write of the information to the nonvolatile device 510, it saves information stored in the nonvolatile device 510 before the write. The history information storage unit 512 stores the information saved by the monitoring unit 511 as history information. When a fault is detected, the restoration unit 513 restores the information stored in the nonvolatile device 510 to its state at a prescribed point of time based on the history information stored in the history information storage unit 512.

The nonvolatile device 510 corresponds to the memory 120 in the aforementioned first exemplary embodiment and the history information storage unit 512 corresponds to the history data storage unit 150 thereof.

According to this fifth exemplary embodiment, employing the aforementioned configuration allows for a transaction process without outputting a transaction log or writing data to a storage device, which takes a relatively long time. Therefore, according to this fifth exemplary embodiment, an advantageous effect of processing a transaction at a high speed can be obtained.

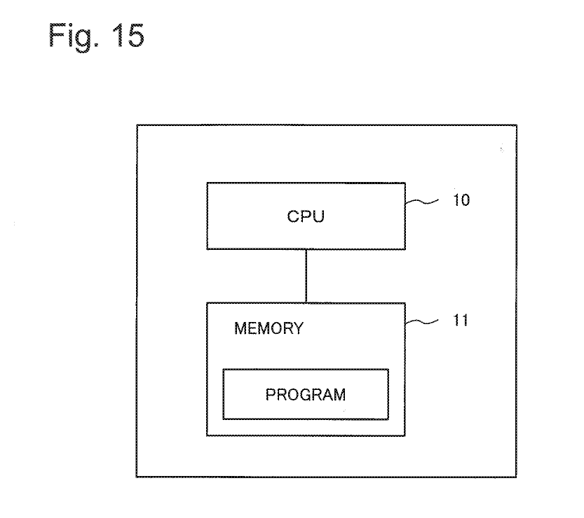

It is to be noted that each unit of the information processing devices shown in FIGS. 1, 5, 8, and 11 is realized in hardware resources illustrated in FIG. 15. It means that according to the configuration shown in FIG. 15, the monitoring unit 130, the restoration units 140 and 330, the DB monitoring unit 230, and the transaction monitoring unit 310 in the information processing devices shown in FIGS. 1, 5, 8, 11 are configured with a CPU 10 that executes on a memory 11 a computer program and various data stored in the memory 11. It is noted that hardware configurations of the information processing devices and each functional block are not limited to the configuration described above.

Also, the present invention explained using each exemplary embodiment as an example is achieved by executing a computer program by the CPU 10 after the computer program that can realize functions explained above is provided for the information processing device.

In addition, such provided computer program may be stored in a readable and writable memory (temporary storage medium) or a computer-readable storage device, such as a hard disk device. In this case, it can be understood that the present invention is configured with codes representing such computer program or a storage medium storing such computer program.

As described above, the present invention is explained with reference to the exemplary embodiments, but is not limited to the aforementioned exemplary embodiments. Various changes that those skilled in the art could understand can be made to configurations or details of the present invention within the scope of the present invention.

This application is based upon and claims the benefit of priority from Japanese Patent Application No. 2014-101950 filed on May 16, 2014, the entire disclosure of which is incorporated herein.

### INDUSTRIAL APPLICABILITY

The present invention, for example, can be applied to an information processing device which includes an in-memory DB.

### REFERENCE SIGNS LIST

10, 110 CPU
11, 120 memory
100, 200, 300, 400, 500 information processing device
130 monitoring unit
140, 330 restoration unit
150 history data storage unit
220 DB area
230 DB monitoring unit
250 DB history data storage unit
310 transaction monitoring unit
320 check point data storage unit

What is claimed is:

1. An information processing device, comprising:
a nonvolatile device into which information pertaining to executed processes is written,
one or more processors acting as monitoring unit configured to save, when detecting a write of the information in the nonvolatile device, the information which has been stored in the nonvolatile device before the write,
history information storage configured to store the information saved by the monitoring unit as history information, and
the one or more processors acting as restoration unit configured to restore, when detecting a fault, the information stored in the nonvolatile device to a state of the information at a prescribed point of time based on the history information stored in the history information storage.

2. The information processing device according to claim 1, wherein the restoration unit identifies, when detecting the fault, a timing of a successful completion of a series of processes of the executed processes and returning information in the nonvolatile device to information retained by the nonvolatile device at the identified timing based on the history information stored in the history information storage.

3. The information processing device according to claim 1, further comprising:
the one or more processors acting as first process monitoring unit configured to detect a timing of a successful completion of a series of processes of the executed processes by monitoring the history information stored in the history information storage and saving the history information at the timing and
first check point data storage configured to store the history information saved by the first process monitoring unit as check point data,
wherein the restoration unit copies, when detecting the fault, the check point data stored in the first check point data storage to the nonvolatile device.

4. The information processing device according to claim 1, wherein the monitoring unit saves, when detecting a write to a database area which stores a result of the executed processes in the nonvolatile device, information stored in the database area before the write, the history information storage stores the information saved by the monitoring unit as database history information, and the restoration unit restores, when detecting the fault, information stored in the database area of the nonvolatile device to a state of the information at a prescribed point of time based on the database history information stored in the history information storage.

5. The information processing device according to claim 4, wherein the restoration unit identifies, when detecting the fault, a timing when a series of processes in the executed processes is successfully completed and restores information in the database area of the nonvolatile device to a state of the information retained by the database area of the nonvolatile device at the identified timing based on the database history information stored in the history information storage.

6. The information processing device according to claim 4, further comprising:
the one or more processors acting as second process monitoring unit configured to detect a timing when a series of processes in the executed processes is successfully completed by monitoring the database history information stored in the history information storage and saving the database history information at the timing and
second check point data storage configured to store the database history information saved by the second process monitoring unit as check point data,
wherein the restoration unit copies, when detecting the fault, the check point data stored in the second check point data storage to the database area of the nonvolatile device.

7. An information processing method, comprising:
storing, when detecting a write of the information in a nonvolatile device into which information pertaining to executed processes is written, the information which has been stored in the nonvolatile device before the write as history information in history information storage,
restoring, when detecting a fault, the information stored in the nonvolatile device to a state of the information at a prescribed point of time based on the history information stored in the history information storage.

8. The information processing method according to claim 7, wherein identifying, when detecting the fault, a timing of a successful completion of a series of processes of the executed processes and returning information in the nonvolatile device to information retained by the nonvolatile device at the identified timing based on the history information stored in the history information storage.

9. The information processing method according to claim 7, further comprising:
detecting a timing of a successful completion of a series of processes of the executed processes by monitoring the history information stored in the history information storage and storing the history information at the timing in first check point data storage as check point data, and
copying, when detecting the fault, the check point data stored in the first check point data storage to the nonvolatile device.

10. A non-transitory computer-readable program recording medium storing a computer program for causing a computer to execute:
a process of storing, when detecting a write of the information in a nonvolatile device into which information pertaining to executed processes is written, the information which has been stored in the nonvolatile device before the write as history information in history information storage,
a process of restoring, when detecting a fault, the information stored in the nonvolatile device to a state of the information at a prescribed point of time based on the history information stored in the history information storage.
